(19) United States
(12) Patent Application Publication
(10) Pub. No.: US 2026/0181395 A1
(43) Pub. Date: Jun. 25, 2026

(54) SYSTEM, METHOD AND APPARATUS FOR CLOUD-BASED MANAGEMENT OF CUSTOMER PREMISES EQUIPMENT

(71) Applicant: Silicon Laboratories Inc., Austin, TX (US)

(72) Inventor: Wael Guibene, McKinney, TX (US)

(21) Appl. No.: 18/923,026

(22) Filed: Oct. 22, 2024

(51) Int. Cl. H04W 12/37; H04W 12/062

(52) U.S. Cl. CPC H04W 12/37; H04W 12/062

(57) ABSTRACT

In one embodiment, a method includes: performing, via a cloud controller of at least one cloud server of an operator of an Internet service provider, a first authentication with a customer premises equipment (CPE) located at a user location remote from the at least one cloud server; after the first authentication, performing a second authentication with a third party application provider; receiving a request from the CPE for direct secure communication between the CPE and the third party application provider; and in response to the request, providing an authentication token to the CPE to enable the CPE to directly securely communicate with the third party application provider using the authentication token and without involvement of the cloud controller.

### BACKGROUND

As more devices in home and other local environments include wireless and smart technology, existing smart home systems often suffer from limited interoperability between devices from different manufacturers. For example, proprietary ecosystems like Apple Homekit, Amazon Alexa, and Google Home prioritize their protocols, leading to fragmented user experiences and the need for multiple hubs or bridges to connect devices. This fragmentation leads to increased costs for users, limited interoperability, and complexity. Also, as smart home environments grow in size and complexity, managing a large number of connected devices becomes challenging. Existing systems struggle with scalability, leading to instability, increased latency, and difficulty in maintaining a consistent user experience.

In addition, current home environments suffer from inconsistent security measures across different smart home ecosystems, particularly when integrating third-party devices. This inconsistency can lead to vulnerabilities, as not all devices adhere to the same security protocols, making the overall system susceptible to attacks. As another challenge, current smart home systems typically rely heavily on cloud processing for certain tasks, which can introduce latency and make the system dependent on a constant Internet connection, leading to delays in automation responses and reduced reliability when connectivity is poor. For these and other reasons, current home systems can be inefficient.

### SUMMARY OF THE INVENTION

In one aspect, a gateway includes: a host main processing unit (MPU), the host MPU comprising at least one core and at least one first transceiver to communicate with one or more first wireless devices in a wireless local area network (WLAN) according to a Wi-Fi protocol; an Internet of Things (IoT) device coupled to the host MPU, the IoT device comprising at least one second transceiver to communicate with each of one or more second wireless devices according to at least one standardized wireless protocol; a first wireless driver to enable the communication with a first device of the one or more second wireless devices according to the at least one standardized wireless protocol comprising a Matter protocol; and a second wireless driver to enable the communication with a second device of the one or more second wireless devices according to the at least one standardized wireless protocol comprising a Thread protocol.

In one implementation, the host MPU is to execute a unified service platform agent to locally enforce unified security of communications between the gateway, the first device and the second device. The unified service platform agent may initiate an authentication with a cloud server of an Internet service provider, and to request an authorization token, the authorization token to enable the gateway to directly securely communicate with a third party application provider.

In an implementation, the host MPU comprises at least one edge node to perform edge processing within the gateway and communicate with at least one cloud server of an Internet service provider, the at least one cloud server comprising an edge microservice orchestrator. The host MPU may execute an edge microservices manager to manage the at least one edge node and communicate with the edge microservice orchestrator. The host MPU may include at least one artificial intelligence (AI) circuit to locally execute AI operations on the gateway.

In an implementation, the gateway further comprises a middleware agent comprising: a plurality of wireless protocol agents comprising: a first wireless protocol agent to perform protocol operations for the Matter protocol and interface with the first wireless driver; and a second wireless protocol agent to perform protocol operations for the Thread protocol and interface with the second wireless driver; at least one first application programming interface (API) to provide an interface between a unified service platform agent and the plurality of wireless protocol agents; and at least one second API to provide an interface between the first wireless protocol agent and the first wireless driver and between the second wireless protocol agent and the second wireless driver.

In an implementation, the at least one first API is to communicate according to a first standardized device data model and the at least one second API is to communicate according to a standardized kernel interface. The middleware agent may enable the first device to communicate with the second device, wherein the first device is to communicate with the gateway via the Matter protocol and the second device is to communicate with the gateway via the Thread protocol.

In another aspect, a method includes: performing, via a cloud controller of at least one cloud server of an operator of an Internet service provider, a first authentication with a customer premises equipment (CPE) located at a user location remote from the at least one cloud server; after the first authentication, performing a second authentication with a third party application provider; receiving a request from the CPE for direct secure communication between the CPE and the third party application provider; and in response to the request, providing an authentication token to the CPE to enable the CPE to directly securely communicate with the third party application provider using the authentication token and without involvement of the cloud controller.

In one implementation, the method further comprises sending, from the cloud controller to the third party application provider, the authentication token to enable the third party application provider to securely communicate with the CPE. The method may also include provisioning the CPE for the user location, the CPE comprising a plurality of wireless protocol stacks to enable the CPE to communicate within one or more mesh networks of the user location according to a plurality of standardized wireless protocols.

In an implementation, the method further comprises: receiving a synchronization message from the CPE, the synchronization message based on local artificial intelligence processing in the CPE; and synchronizing with at least one cloud service in the at least one cloud server based at least in part on the synchronization message. The method may further comprises sending, from the cloud controller, an update for a first wireless protocol stack of the CPE via a unified service platform agent of the CPE to cause the first wireless protocol stack to be updated without user involvement. The method may further include: initiating, via the cloud controller, a security check of the CPE; and based at least in part on the security check, performing an update of the CPE via the cloud controller without involvement of a user of the CPE.

In yet another aspect, a method comprises: performing a first authentication between a CPE and a cloud controller of at least one cloud server of an operator of an Internet service provider, the CPE located at a user location remote from the at least one cloud server; sending a request to the cloud controller to seek authorization to securely directly communicate with a third party application provider; in response to the request, receiving an authentication token; and using the authentication token, directly securely communicating with the third party application provider.

In an implementation, the method further comprises: communicating with a first wireless device in a network at the user location via a first wireless driver of the CPE according to a Matter protocol; and communicating with a second wireless device in the network at the user location via a second wireless driver of the CPE according to a Thread protocol. The method may also include: performing, within an edge node of the CPE, edge processing of sensor information received from a first wireless device in a network at the user location; and after performing the edge processing, communicating with an edge microservice orchestrator of the at least one cloud server. The method may also include: analyzing, via an AI engine of the CPE, a result of the edge processing; and based on the analyzing, performing one or more operations in the CPE.

In an implementation, the method further comprises: receiving, in the CPE, sensor information from a first wireless device in a network at the user location; providing at least a portion of the sensor information to an edge node for edge processing to obtain edge processing result information; performing, in the CPE, real-time analysis of the edge processing result information; and based at least in part on the real-time analysis, performing, via an artificial intelligence agent of the CPE, one or more local actions within the CPE.

In one or more implementations, the method may be performed in response to instructions stored in at least one non-transitory computer-readable medium. Such instructions, when executed by at least one processor of a CPE, cause the CPE to perform the above-described methods.

### BRIEF DESCRIPTION OF THE DRAWINGS

FIG. 1 is a block diagram of a wireless environment having a gateway device in accordance with an embodiment.

FIG. 2 is a block diagram of a network in accordance with an embodiment.

FIG. 3 is a transaction diagram illustrating transactions occurring between various entities in accordance with an embodiment.

FIG. 4 is a flow diagram of a service orchestration method in accordance with an embodiment.

FIG. 5 is a flow diagram of a method in accordance with another embodiment.

FIG. 6 is a flow diagram of a device and services lifecycle management method in accordance with an embodiment.

FIG. 7 is a flow diagram of a method for edge microservices orchestration in accordance with an embodiment.

FIG. 8 is a flow diagram of a hybrid cloud interaction method in accordance with an embodiment.

FIG. 9 is a block diagram of a home network in accordance with an embodiment.

### DETAILED DESCRIPTION

In various embodiments, an infrastructure is provided to manage and operate smart home environments. To this end, embodiments provide a scalable and secure architecture that integrates both edge computing and cloud-based services to create a seamless, interoperable smart home ecosystem. In this way a unified smart home management framework is realized that enables management of a diverse range of smart home devices from different manufacturers using standardized communication protocols including but not limited to Matter, Zigbee, and Thread, ensuring that devices can communicate and work together seamlessly, regardless of their brand or origin.

Embodiments may also provide edge and cloud integration by incorporating an edge microservice orchestrator to manage services locally at the edge of the network, reducing latency and improving real-time responsiveness. Cloud microservices, managed through a unified service platform (USP), may be configured to handle more complex tasks and provide centralized control. Embodiments further ensure security and reliability by implementing consistent security protocols across all devices and communications, ensuring robust protection against vulnerabilities. To this end, a unified security model can operate both at the edge and in the cloud.

With embodiments, scalability and flexibility is realized via the modular and scalable framework, allowing for easy expansion as new devices are added. In this way, embodiments can adapt to evolving smart home environments, whether in small residential settings or larger, more complex setups. The infrastructure described herein can be provided as an operator-managed environment.

Unlike traditional user-managed smart home systems, this framework allows operators to handle maintenance, updates, and security, providing a more hands-off experience for end users. This approach simplifies the management process and ensures the system remains up-to-date and secure.

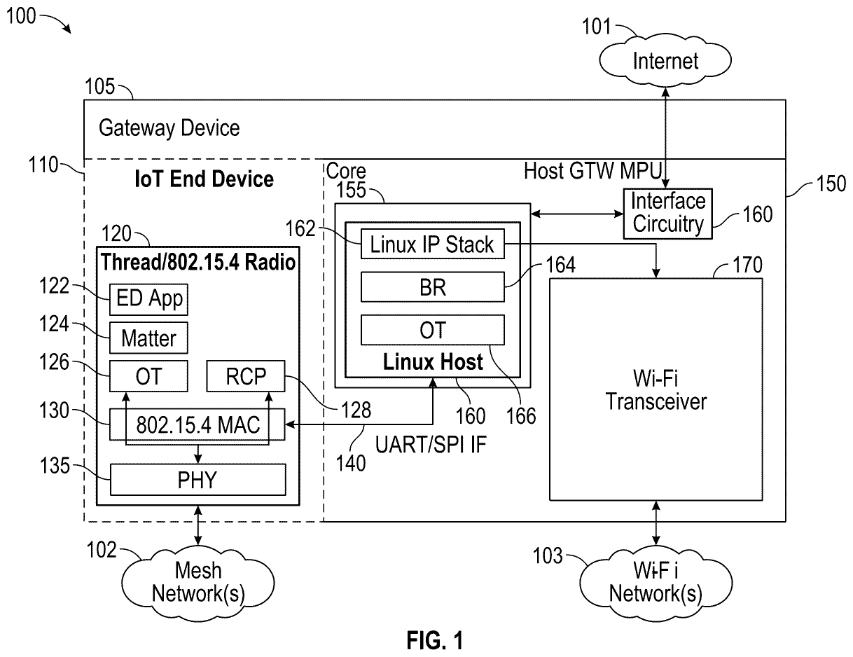

Referring now to FIG. 1, shown is a block diagram of a portion of a wireless environment having a gateway device in accordance with an embodiment. As shown in FIG. 1, wireless environment 100 may be present in a home or other building or environment. Wireless environment 100 includes a customer premises equipment 105, also referred to as a gateway device, that can provide an interface to the Internet 101, for one or more devices present in one or more wireless local area networks (WLANs) 103 (e.g., the Wi-Fi network shown in FIG. 1). Gateway device 105 further enables communication with one or more devices in one or more mesh networks 102 (e.g., Bluetooth Low Energy (BLE), Thread, or other such mesh networks). In one or more embodiments, gateway device 105 may be provided by an Internet service provider (also referred to as an operator) to its customers.

As shown gateway device 105 includes an IoT device 110 and a host gateway microprocessing unit (MPU) 150. Gateway device 105 may be implemented as a system that supports Matter devices using an OpenThread Border Router (OTBR) through a Thread-capable chip.

In embodiments, IoT device 110 may be an actual IoT device within gateway 100, such as a component of an IoT home network. As examples, IoT device 110 may be a sensor, appliance controller or so forth. In other cases, IoT device 110 may be implemented as a low power wireless system on chip (SoC), such as may be implemented in a standalone integrated circuit (IC). At a high level, such SoC may include one or more processors, memory, non-volatile storage (which may store firmware and other code) and additional components. Understand that as used herein, IoT device 110 is also referred to as a “gateway end device” or an “IoT end device,” indicating that this device is separate from host gateway MPU 150 and can be identified through a mesh network as an end node device.

In the high level view shown in FIG. 1, IoT device 110 includes a radio 120. In the embodiment shown, radio 120 may be implemented as a Thread/IEEE 802.15.4 radio. As illustrated, radio 120 includes an end device application 122, which is an application running on the end device that interacts with other devices and services in the network when host gateway MPU 150 is in a sleep mode.

In turn, a Matter stack 124 is configured to handle communication using the Matter protocol, ensuring interoperability between smart home devices. An OpenThread (OT) stack 126 provides the implementation of the Thread networking protocol corresponding to an OT stack present on host gateway MPU 150. A Radio Co-Processor (RCP) 128 may be implemented as a dedicated processor for handling radio communication tasks, offloading these from the main application processor.

Still referring to FIG. 1, radio 120 further includes a Media Access Control (MAC) layer 130, which may be implemented as an IEEE 802.15.4 layer to manage access to a physical radio channel, and handle tasks like addressing and channel access. A Physical Layer (PHY) 135 is configured to be responsible for the transmission and reception of radio signals to devices within mesh network 102.

Still referring to FIG. 1, gateway device 105 also includes host gateway MPU 150 (also referred to herein as a “host” or “host processor”). MPU 150 may include one or more processors such as a representative core 155 to handle various functionality, including implementation of a computing environment 160. As further shown MPU 150 also includes a wireless transceiver 170, which as shown may be implemented as a Wi-Fi transceiver (which may be part of a multi-protocol transceiver).

As shown, IoT device 110 communicates with host MPU 150 via an interface 140. In embodiments, interface 140 may be a physical interface implemented as a wired interface. In various embodiments, interface 140 may communicate according to a Universal Asynchronous Receiver/Transmitter (UART) or Serial Peripheral Interface (SPI) to provide for data communication.

Computing environment 160 may be implemented as a general-purpose computing environment that hosts various components. As shown, computing environment 160 includes a Linux IP stack 162, which may be configured as a network stack running on a Linux operating system, to handle IP-based communication. Computing environment 160 also includes a Border Router (BR) 164 to manage the traffic between different network segments, and acts as a bridge between the Thread network and other IP-based networks. Computing environment 160 also includes an OT stack 166 to provide network management and routing functions.

In turn, Wi-Fi transceiver 170 provides wireless connectivity for gateway device 105, to communicate with one or more devices present in WLAN network(s) 103. As further shown, MPU 150 couples to an interface circuit 180, which may be an Ethernet interface to couple the gateway to Internet 101 (and/or other networked devices). Although shown at this high level in the embodiment of FIG. 1, understand that many variations and alternatives are possible. For example, in other implementations, there may be a single SoC or other IC that incorporates both host processor and radio functionality.

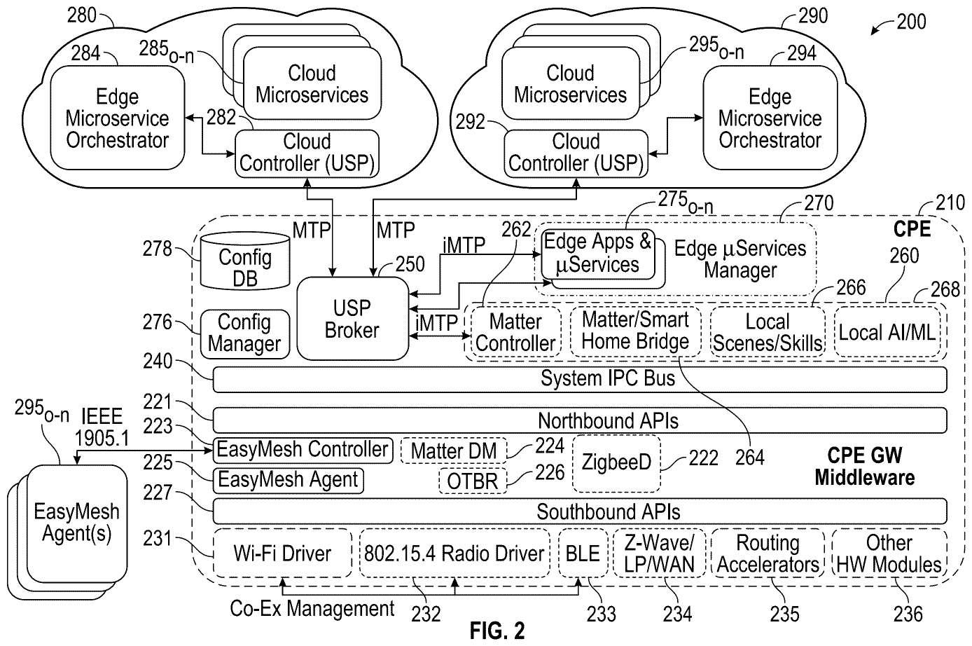

Referring now to FIG. 2, shown is a block diagram of a network in accordance with an embodiment. As shown in FIG. 2, network 200 includes multiple computing systems and a CPE 210. More specifically, CPE 210 is a customer premises equipment in accordance with an embodiment that enables various features as described herein.

As shown, CPE 210 is in communication with an operator 280. More specifically, operator 280 may be an Internet service provider that provides CPE 210 to a customer. Operator 280 may include a plurality of cloud-based servers and other computing equipment. In the high level shown in FIG. 2, operator 280 may interact with CPE 210 using a cloud controller 282, which may implement a USP in accordance with an embodiment. In turn, cloud controller 282 communicates with an edge microservice orchestrator 284, which also may be implemented via one or more cloud-based servers, and may be responsible for updating and maintaining CPE 210. Edge microservice orchestrator 284 manages the deployment, updating, and maintenance of edge services, ensuring that smart home operations are handled locally when possible to reduce latency. Note that such updating, e.g., firmware, middleware or other code of CPE 210 may occur autonomously via orchestrator 282, without incurring a restart of CPE 210, in a manner transparent to a user.

The cloud services, managed by a USP within cloud controller 282, oversee more complex operations and provide centralized control and data synchronization. In addition, operator 280 can provide a plurality of microservices 285_{0-N}, each of which may be implemented on one or more cloud-based servers. Although embodiments are not limited in this regard, example cloud microservices 285 include provisioning, orchestration, security, and automation, among others. As shown, operator 280 may communicate with CPE 210 via an MTP protocol, although other protocols are possible.

CPE 210 also may be in communication with one or more third party application providers 290. More specifically, application provider 290 may be a service provider that provides one or more services to CPE 210, such as streaming services, gaming services, computing services or so forth. Like cloud 280, application provider 290 may include a plurality of cloud-based servers and other computing equipment. In the high level shown in FIG. 2, provider 290 may interact with CPE 210 using a cloud controller 292, which may implement a USP in accordance with an embodiment. In turn, cloud controller 292 communicates with an edge microservice orchestrator 294, which also may be implemented via one or more cloud-based servers, and may be responsible for updating and maintaining CPE 210 with respect to a plurality of cloud microservices 295₀₋ₙ.

Still referring to FIG. 2, CPE 210 is illustrated at a functional level, including various hardware, firmware and software. Note that in a particular implementation, CPE 210 may implement the hardware arrangement of CPE 100 of FIG. 1.

CPE 210 includes gateway (GW) middleware 220. Middleware 220 may communicate with various low level drivers and other modules via a set of southbound application programming interfaces (APIs) 229, which in an embodiment, may be based on Linux kernel standard interfaces. In turn, gateway middleware 220 may communicate with upstream components via northbound APIs 221, which may be based on the TR-181 protocol, e.g., including WFA data elements and USP.

Gateway middleware 220 includes various drivers, controllers and other agents. Specifically shown, middleware 220 includes a Zigbee Daemon (ZigbeeD) which may provide a protocol stack for Zigbee communication, a Matter device model (DM) 224 to provide a Matter protocol stack, and an Open Thread Boarder Router (OTBR) 226 to provide for Thread-based communication. In addition, middleware 220 includes an EasyMesh controller 223 to provide control of an internal EasyMesh agent 225 and which may, in turn, communicate with external EasyMesh agents 295_{0-N} which may be, e.g., remote extenders. As shown, such communication may be via an IEEE 1905.1 protocol.

Still with reference to FIG. 2, middleware 220 includes various drivers and other modules to enable communication according to various standardized protocols. Thus as shown, a Wi-Fi driver 231, an IEEE 802.15.4 radio driver 232 and a Bluetooth low energy (BLE) driver 233, enable communication via these various standardized communication protocols, and middleware 220 can manage co-existence between the various communication protocols. As further shown, a Z-wave/LP low power wide area network (LPWAN) driver 234 along with one or more routing accelerators 235 and other hardware modules 236 also may be implemented within middleware 220.

As further shown, CPE 210 enables communication between northbound APIs 221 and a system inter-processor communication (IPC) bus 240, which may communicate using a standardized protocol and/or USP internal iMTP protocol. In this way, communications may occur with a USP broker 250 that interfaces, e.g., via MTP communications with operator 280 and third parties 290. USP broker 250 is configured with access controls to enable secure communication between devices within one or more wireless networks at a user location and the cloud, ensuring that all data transfers are encrypted and protected from unauthorized access. This creates a consistent security environment across the entire system.

In embodiments, USP broker 250 may handle access controls to allow communication between the various components. As further shown, USP broker 250 provides an interface with a set of local agents 260, including a Matter controller 262, a Matter/smart home bridge 264, a local scenes/skills module 266 and a local AI/ML agent 268. With these modules, greater processing can be performed locally, reducing latencies. In different implementations, local scenes/skills module 266 enables a range of smart home functionalities, including managing predefined “scenes” (e.g., “Movie Time” that adjusts multiple devices), executing predefined “skills” based on user input or triggers, event-triggered actions (e.g., turning off lights at sunrise), and user-customized automations. By processing these activities locally, latency is reduced and real-time control is enhanced, supporting diverse automations and personalized routines without relying on cloud services.

USP broker 250 also interfaces with an edge microservices manager 270, which in turn may manage local edge applications and microservices 2750-n. Note that such edge components may be referred to as edge nodes, in that they can more locally perform edge processing, particularly where operator 280 pushes services down for execution on CPE 210.

Still referring to FIG. 2, USP 250 also interfaces with a configuration manager 276. In embodiments herein, configuration manager 276 may perform configuration operations for CPE 210, which may proceed under control of operator 280. As also shown, configuration manager 276 interfaces with a configuration database 278, which may be a local database in which configuration settings and other configuration information may be stored.

Understand that CPE 210 may include a user interface via which users interact with the system through a unified interface that provides control over all connected devices. In an embodiment, operator 280 manages this interface, ensuring it remains user-friendly and consistent, with updates handled automatically. Although shown at this high level in the embodiment of FIG. 2, many variations and alternatives are possible.

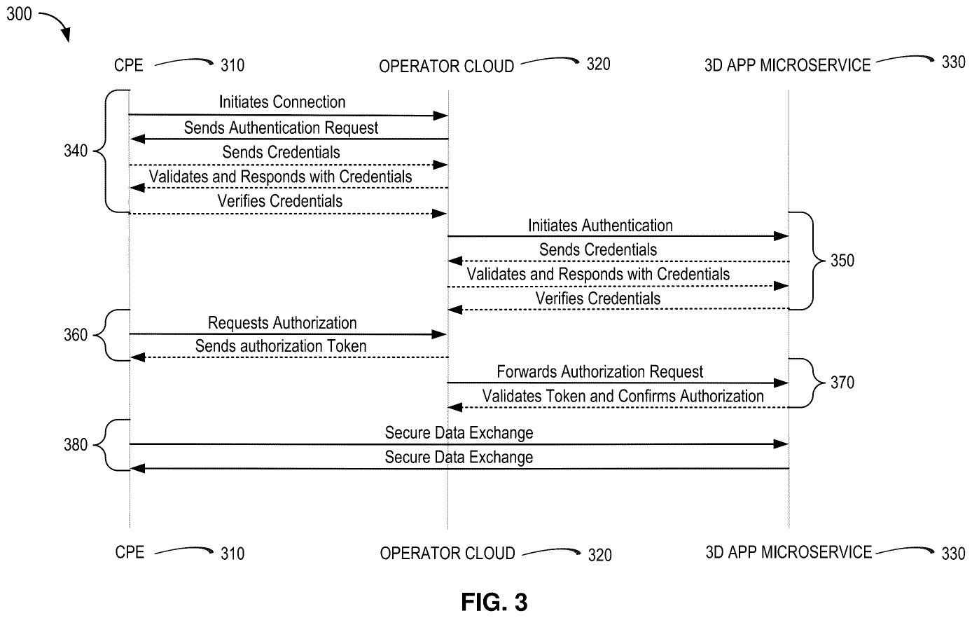

Referring now to FIG. 3, shown is a transaction diagram illustrating transactions occurring between various entities in accordance with an embodiment. More specifically, as shown in FIG. 3, illustration 300 describes a 3-way authentication performed between a CPE 310, an operator cloud 320 and a third-party application microservice 330. To effect the direct interoperability between CPE 310 and microservice 330, first an initial authentication proceeds between CPU 310 and cloud 320 that implements a first set of transactions 340. As shown in FIG. 3, transactions 340 may begin by initiation via CPE 310, which initiates a connection, triggering cloud 320 to send an authentication request. In response to this authentication request, CPE 310 sends a set of credentials which, in an embodiment, may include a device ID and a secure authentication token. Cloud 320 validates these authentication credentials and responds with additional credentials, which may include a session token and encryption keys. In turn, CPE 310 verifies these credentials with cloud 320.

As one example, a typical CPE request to the cloud involves retrieving updates for device configurations, requesting new service activations, and/or interacting with cloud-based IoT services. Referring now to Table 1, shown is an example request structure in accordance with an embodiment, which may be implemented with a Javascript objection notation (json) format.

TABLE 1

```
{
  “cpe_id”: “CPE12345”,
  “request_type”: “SERVICE_ACTIVATION”,
  “service_id”: “service001”,
  “timestamp”: “2024-09-13T10:23:45Z”,
  “authentication_token”: “ABCDEF1234567890”,
  “parameters”: {
  “device_configuration”: {
  “wifi_ssid”: “HomeNetwork”,
  “wifi_password”: “securepassword”
  },
  “service_parameters”: {
  “cloud_storage”: true,
  “backup_frequency”: “daily”
  }
  }
    }
```

In this request, the CPE is asking the cloud for the activation of a service (SERVICE_ACTIVATION), passing configurations and may also include an authentication token (e.g., a previously issued authentication token).

Still with reference to FIG. 3, cloud 320 initiates a second set of transactions 350 between it and microservice 330. Transactions 350 generally track the same authentication operations discussed above, as shown in FIG. 3. At the conclusion of this authentication, both CPE 310 and microservice 330 are authenticated with respect to cloud 320.

Still referring to FIG. 3, CPE 310 initiates another set of transactions 360 to request authorization for direct interaction between CPE 310 and microservice 330. As shown, transactions 360 include an authentication request for direct access to microservice 330, which results in cloud 320 sending an authorization token to CPE 310. Note that this authentication token can be a temporary session token (or a long-lived token) used to verify the identity of the CPE in subsequent communications. Thereafter, cloud 320 initiates a further set of transactions 370 with microservice 330 to forward this authorization request to microservice 330, which validates the received authorization token and confirms authorization.

Thus, at this point, the devices are configured to enable direct secure communications between CPE 310 and microservice 330. Accordingly, as further shown in FIG. 3, a set of secure transactions 380 may proceed. Via secure transactions 380, secure data may be exchanged directly between CPE 310 and microservice 330, without involvement of cloud 320. CPE 310 may use the authentication token to establish secure communications with microservice 330.

Referring now to Table 2, shown is an example of using an authentication token in a request to a third-party provider:

TABLE 2

{
“cpe_id”: “CPE12345”,
“third_party_service_id”: “3PPService001”,
“timestamp”: “2024-09-13T10:30:15Z”,
“authentication_token”: “ABCDEF1234567890”,
“request_type”: “SERVICE_UPDATE”,
“parameters”: {
“update_type”: “firmware”,
“version”: “v1.2.3”
}
}

In this case, the authentication token (ABCDEF1234567890) is used to verify the CPE's identity when communicating with the third-party provider (3PP), ensuring that the request is authenticated and secure.

In some embodiments, cloud 320 can act as a broker, where the token provided during the authentication can be validated by third-party services through cloud 320. In yet other interactions with third-party services, such as obtaining updates, data exchange, or service management, CPE 310 may include the authentication token to prove that it has been authenticated by cloud 320, and in some cases, microservice 330 can validate this assertion with cloud 320. Although shown at this high level in the embodiment of FIG. 3, understand that many variations and alternatives are possible.

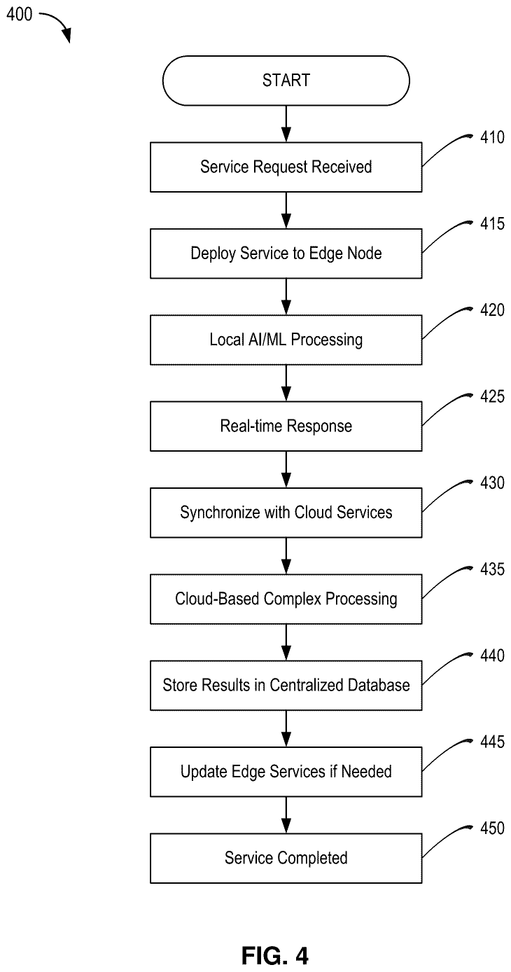

Referring now to FIG. 4, shown is a flow diagram of a service orchestration method in accordance with an embodiment. More specifically, method 400 of FIG. 4 is a method for orchestrating a service to be performed more locally with respect to a CPE, reducing cloud interaction and thus latency, improving user experience.

As shown, method 400 begins by receiving a service request (block 410). As examples, this service request may be for edge processing, which could involve updating or managing applications or microservices that run locally on the CPE. For instance, if the CPE is responsible for local AI tasks (such as video processing or automation), a typical request may be as shown below in Table 3, which is a service request example for an edge node AI processing update in accordance with an embodiment

TABLE 3

{
“cpe_id”: “CPE12345”,
“request_type”: “UPDATE_EDGE_SERVICE”,
“service_id”: “local_ai_video_processing”,
“timestamp”: “2024-09-13T14:00:00Z”,
“authentication_token”: “TOKEN_XYZ123”,
“parameters”: {
“service_configuration”: {
“ai_model_version”: “v2.0”,
“processing_type”: “object_detection”,
“video_source”: “camera001”,
“processing_frequency”: “real-time”
}
}
}

This request in Table 3 involves updating a local AI video processing service that operates on the CPE, and the service configuration shown specifies a new version of the AI model to be used for object detection, and includes configuration details about the input source and processing frequency.

In the context of a smart home network, an edge node typically refers to a system that performs processing close to where data is generated, such as a CPE. There are different locations for an edge node in various embodiments.

In one embodiment, the CPE may implement one or more edge nodes. Here, the CPE functions as the edge microservice manager, where edge services such as local AI processing, automation, and real-time control take place. The edge node in this case resides within the user's home network (e.g., the CPE). One ready example of such implementation is a CPE running a service that processes video streams from a home camera and detects motion locally before sending the results to the cloud.

In another embodiment, the edge infrastructure may be implemented in the cloud but close to the home. That is, some edge services might be deployed in an infrastructure closer to the user, often referred to as a near-home edge data center. This type of edge node sits between the user's home and the cloud, enabling quicker responses and processing (e.g., for low-latency tasks). In an example, a regional data center close to the user can handle heavy data processing for smart home devices, such as advanced machine learning tasks that require more computational resources than are available on the CPE.

Still referring to FIG. 4, the requested service is deployed to an edge node (block 415). In one embodiment, this edge node may be implemented within the CPE, e.g., to be managed by an edge microservices manager of the CPE. When handling this service, the CPE may perform local AI/ML processing (block 420). As an example, this local processing may include receiving and processing sensor inputs via a local AI/ML model. Other examples of edge processing may include identifying malicious activity such as denial of service (DNS) attacks, malicious activity in local networks, or other rogue behavior. Given the local nature of these operations, at block 425, a real-time response may be generated, and in some cases may be communicated to synchronize with the cloud services (block 430).

Still referring to FIG. 4, if needed, cloud-based complex processing may be performed at block 435. This complex processing may include various operations of a more compute-intensive nature, which is more efficiently performed in the cloud. For example, certain of these more complex operations may require interfacing with data that is present remotely from the local device. The results of such processing may be stored in a centralized database, e.g., a database of the operator (block 440).

Still referring to FIG. 4, the edge services may be updated if needed (block 445). As an example, an updated model that is based on analysis of field data of a large amount of CPEs in the field can be provided to the CPE. In another case, the edge services update can be based on local AI and cloud interaction. An edge service update could involve the cloud sending new AI models or updated services to the CPE to enhance local processing capabilities. Finally, the service completes (block 450).

Referring now to Table 4, shown is an example edge node update in accordance with an embodiment.

TABLE 4

{
“cpe_id”: “CPE12345”,
“request_type”: “DEPLOY_AI_UPDATE”,
“application_id”: “home_security_ai”,
“timestamp”: “2024-09-13T15:00:00Z”,
“authentication_token”: “TOKEN_XYZ123”,
“parameters”: {
“ai_model_version”: “v3.1”,
“update_type”: “cloud_optimized”,
“local_fallback”: true,
“sync_frequency”: “daily”
}
}

As shown in Table 4, the CPE is receiving an updated AI model (v3.1) for a home security AI service. This update leverages cloud-optimized AI for tasks that require intensive processing but includes a local fallback mechanism if cloud connectivity is lost. Per this update, the CPE will synchronize updates daily, ensuring that it always has the latest version of the AI model. This interaction combines both local AI processing and cloud-based optimization, ensuring that critical tasks (like security alerts) can continue even when there is no cloud connection.

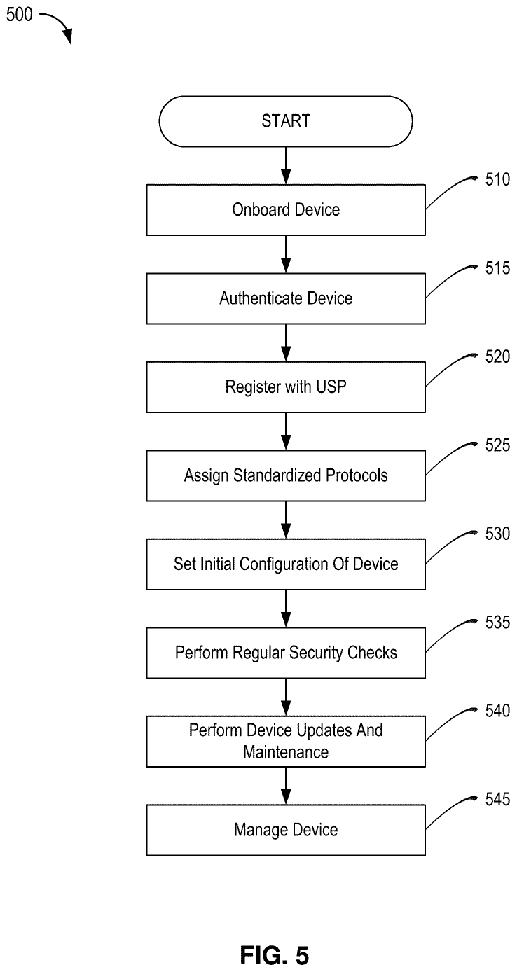

Referring now to FIG. 5, shown is a flow diagram of a method in accordance with another embodiment. More specifically, method 500 of FIG. 5 is a method for remotely managing a user device, such as a CPE. Method 500 may be performed by one or more operator cloud servers. As shown, method 500 begins by onboarding the device (block 510). Such onboarding may be performed when a user plugs the CPE in for the first time, to enable initial communication between the CPE and the operator to onboard the EP into the operator's network. Next at block 515, the operator may authenticate the device. This authentication may be based at least in part on authentication information stored in a non-volatile memory of the CPE, such as within a flash memory, security token or other non-volatile storage.

Still referring to FIG. 5, at block 520, the CPE may be registered with a USP. This USP may be the USP of a cloud controller of the operator. Next at block 525, the operator assigns standardized protocols to the CPE. For example, the operator can identify one or more standardized protocols to enable the CPE to wirelessly communicate according to selected standardized protocols. Although embodiments are not limited in this regard, the standardized protocols may include Wi-Fi in accordance with a given IEEE 802.11 standard, and one or more of Matter, Thread, Zigbee, and/or Z-Wave protocols and/or one or more Bluetooth protocols. With these assigned standardized protocols, at block 530, the operator can set an initial configuration of the device. Such initial configuration may include providing firmware and/or software to enable the CPE to communicate according to the assigned standardized protocols, along with additional firmware to enable operation of the CPE and further to engage in wired communications via the Internet, e.g., according to the operator's protocols.

As this point, the CPE is configured for normal operation, and the device is ready for provisioning to a user to begin normal operation. Note that during a lifecycle of the CPE in the field, the operator may effect additional management, maintenance and other operations. Thus as further shown in FIG. 5, at block 535, the operator may perform regular security checks, to ensure that the CPE remains updated with respect to functionality, security or so forth. For example, the operator may regularly perform a scan of the CPE to ensure no malicious activity and further to provide any updated patches, as appropriate. Next at block 540, the operator may choose to perform device updates and maintenance, such as providing additional services and handling maintenance events, e.g., in response to an error, which may be reported to the operator. In an embodiment such maintenance events may involve various actions the operator undertakes to maintain and optimize the performance, security, and functionality of the device. These events include routine health checks to verify operational status, performing software updates and applying security patches to protect against vulnerabilities, and addressing errors through troubleshooting. Additionally, performance optimization tasks may be conducted by adjusting settings to improve efficiency, while data synchronization ensures consistency with cloud services. Configuration management involves modifying device settings based on user requirements or network changes. Furthermore, the operator may handle device lifecycle management, such as decommissioning outdated devices or provisioning new ones, ensuring continued reliability and an optimal user experience.

Thus the embodiment of FIG. 5 demonstrates cloud-driven security, update management, and service orchestration, alongside the use of standardized protocols for interoperability. Stated another way, the cloud handles centralized security enforcement and service management, ensuring consistent, real-time updates for both security patches and device firmware. This automated, operator-driven management significantly reduces the user's burden while ensuring robust security across all devices. By providing standardized protocols for interoperability, seamless communication between devices from different manufacturers can be realized, removing traditional barriers of proprietary ecosystems, allowing devices to work together without complex integrations. Still further, seamless updates may be realized via cloud-controlled, automatic service and firmware updates to ensure that devices remain secure and optimized without manual user intervention. The integration of standardized security measures across the entire ecosystem ensures continuous protection against vulnerabilities. Thus with embodiments, the cloud has an active and primary role in securing, updating, and managing the entire smart home environment while maintaining interoperability through standardized protocols, offering a future-proof, scalable solution.

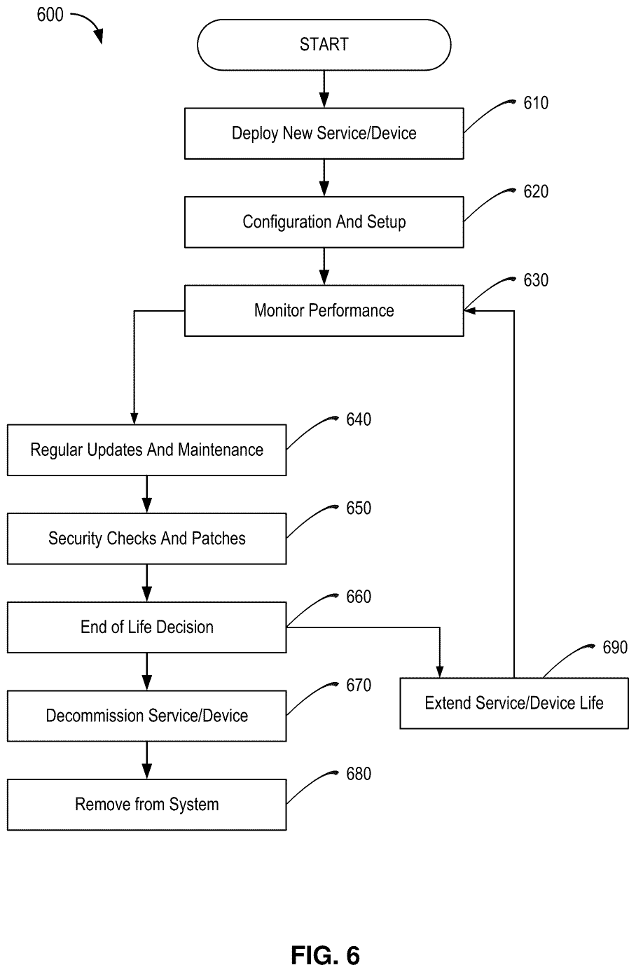

Referring now to FIG. 6, shown is a flow diagram of a device and services lifecycle management method in accordance with an embodiment. As shown in FIG. 6, method 600 may be performed by the operator, e.g., via one or more operator cloud servers to perform management of CPEs in the field, such as, described above at block 545 of FIG. 5.

In the illustrated embodiment, various management activities may be performed via communication between the CPE at a user location and one or more cloud servers. These operations may include deployment of a new service and/or device (block 610), and configuration and setup (block 620). Thereafter, additional management operations during a lifecycle of the CPE may occur. As illustrated, the operator may monitor performance of the device (block 630). Such monitoring may be performed according to a regular schedule and may include receiving self-test results, responses to queries by the operator and so forth. Based at least in part on the performance monitoring, at block 640, the operator may perform any regular updates and/or needed maintenance. At block 650, the operator may perform security checks and issue appropriate patches.

Depending upon test results, age of the equipment and so forth, the operator may make an end-of-life decision at block 660. If various metrics are met, the device may remain in the field as the operator extends the service/device lifetime (block 690). Otherwise, if the decision is made to end operation of the service/device, control passes to block 670 where the service/device may be decommissioned. Finally, at block 680, information regarding the particular device can be removed from the operator system, e.g., database of commissioned and active devices.

Thus the embodiment of FIG. 6 demonstrates cloud-driven security, update management, and lifecycle orchestration, combined with standardized protocols. Stated another way, the cloud actively manages device security, ensuring consistent and seamless updates for firmware, applications, and security patches, removing user burden and ensuring devices are always up-to-date and secure. Also, the cloud performs lifecycle management of services, as the cloud can handle the entire lifecycle of services, including deployment, scaling, and decommissioning. This central control of service orchestration enhances system efficiency and reliability, particularly for complex smart home environments. Although shown at this high level in the embodiment of FIG. 6, many variations and alternatives are possible.

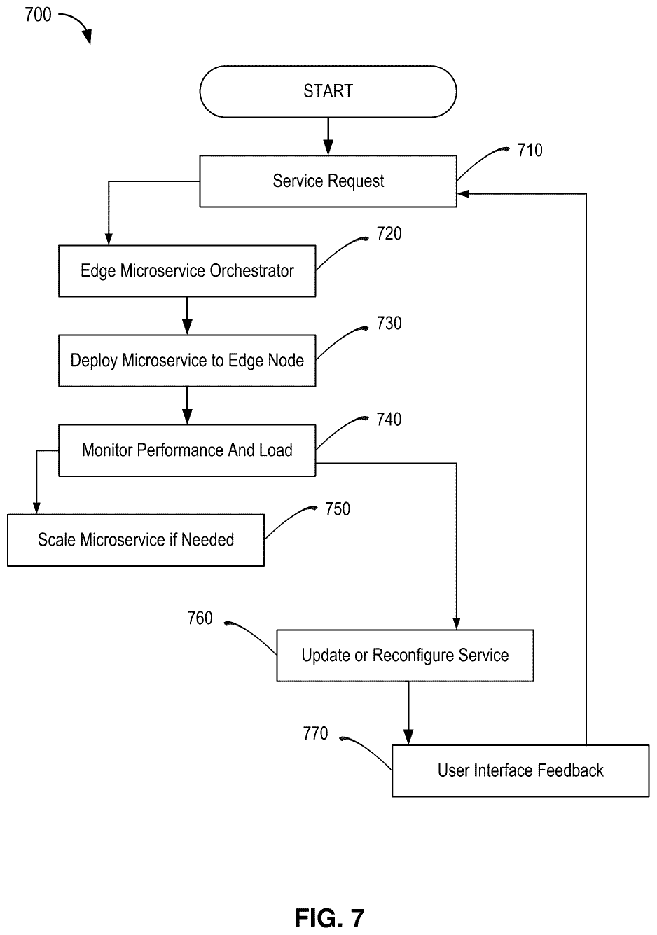

Referring now to FIG. 7, shown is a flow diagram of a method for edge microservices orchestration in accordance with an embodiment. As shown in FIG. 7, method 700 may be performed by an edge microservice orchestrator. Although embodiments are not limited in this regard, this orchestrator may be implemented within an operator or third party provider network, e.g., within the cloud or within the network edge. As illustrated, method 700 begins by receiving a service request (block 710). This service request may be a request from a given microservice in operation on the CPE. The service request, in turn, is provided to the edge microservice orchestrator (block 720). In an embodiment, the orchestrator validates the service request, assess the current load and resource availability, and determines an optimal deployment strategy for the microservice. In some cases, the orchestrator may also perform pre-deployment checks to ensure compatibility and security compliance before proceeding to deploy the microservice to the edge node. Next, at block 730, a given microservice may be deployed to the edge node. At this point, the microservice is ready for operation and may perform requested operations that are appropriate for the given microservice function.

During such normal operation, the microservice orchestrator may monitor performance of the microservice and its load (block 740). To this end, the edge node may send regular performance monitoring information to the orchestrator to effect this monitoring. If it is determined that the microservice is undergoing a high load, control can pass to block 750 where the microservice is scaled. To this end, additional instances of the microservice can be provisioned to the edge node. Also, depending upon the monitoring of performance, the microservice can be updated and/or reconfigured (block 760). Note, also, that a user may provide feedback via a user interface (block 770) which may trigger another service request. Although shown at this high level in the embodiment of FIG. 7, many variations and alternatives are possible.

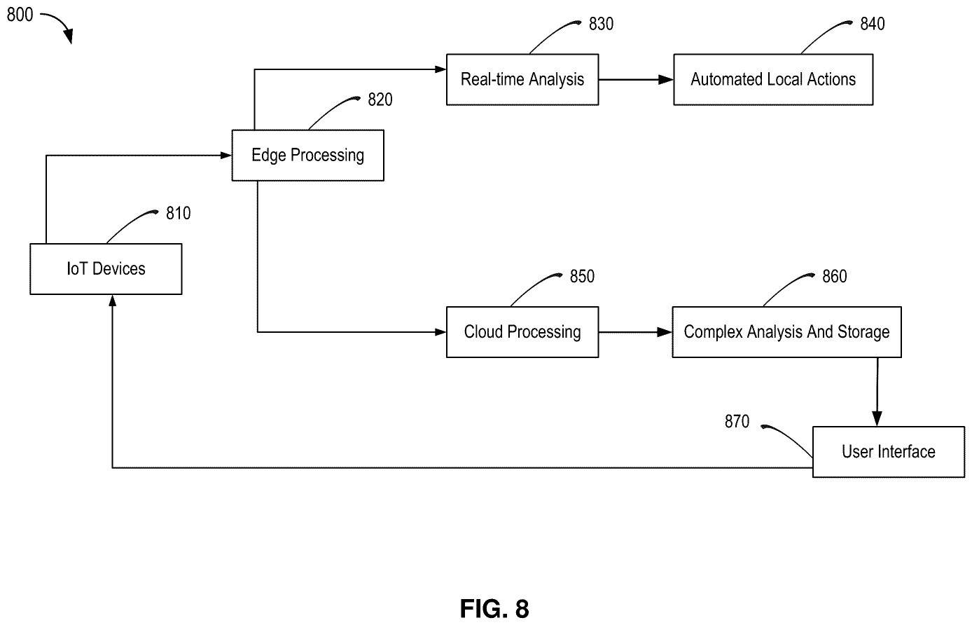

Referring now to FIG. 8, shown is a flow diagram of a hybrid cloud interaction method in accordance with an embodiment. As shown in FIG. 8, method 800 may be used to enable interaction between various entities, ranging from IoT devices and CPE devices within a user home or other environment, to edge and cloud resources that can be remotely located. Specifically, as shown, a user can interact with one or more IoT devices 810 via a user interface 870. In different implementations, this user interface can take the form of a remote control, a user's smartphone, tablet, PC or so forth and/or a direct user interface of the CPE.

As also illustrated in FIG. 8, IoT devices may communicate with and benefit from edge processing 820 that can be done at one or more edge nodes. By way of such processing, real-time analysis may occur at block 830. Automated local actions can be performed at block 840. Although embodiments are not limited in this regard, one example of real-time processing is in the context of a smart home security system. In such a setup, IoT devices like cameras and motion sensors are connected to an edge node, such as a local gateway device. When a motion sensor detects movement, the edge node processes this data in real-time (e.g., at block 830) to identify whether the motion is from a human or another source, using a pre-trained machine learning model. Based on this analysis, the system can automatically trigger local actions (block 840), such as turning on the lights, locking doors, or sending an alert to the homeowner's smartphone, all without relying on cloud processing. This local edge processing reduces latency, enabling quick and reliable responses to potential security threats.

Also, based at least in part on the edge processing, communications may occur with one or more cloud servers, e.g., of an operator and/or third party. Such cloud processing shown at block 850 may result in complex analysis and storage of data and other information, as shown at block 860. At least some of this information, e.g., in the form of performance data or so forth, can be shared with the user via user interface 870.

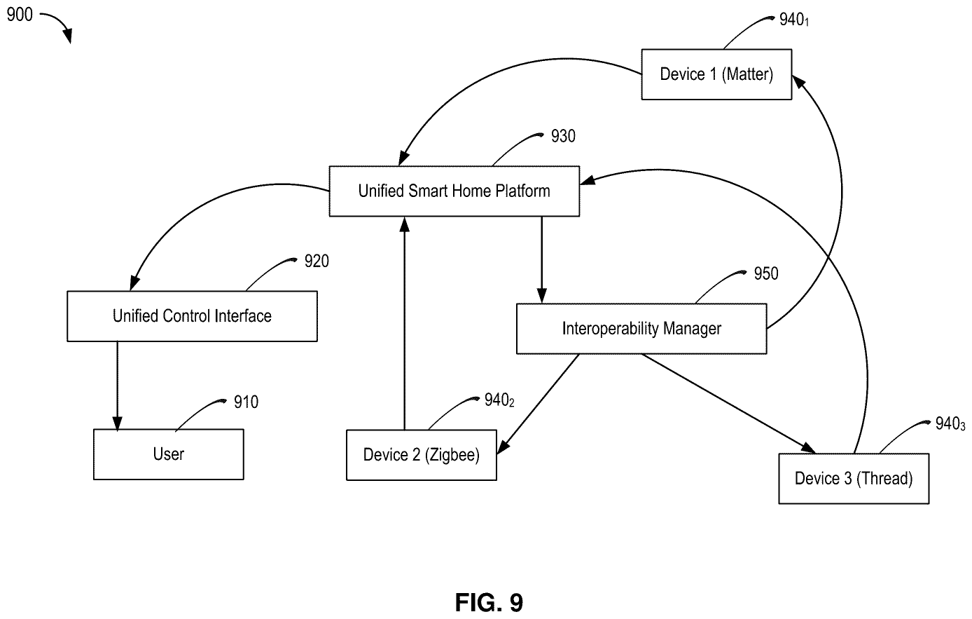

Referring now to FIG. 9, shown is a block diagram of a home network in accordance with an embodiment. As illustrated in FIG. 9, home network 900 includes a variety of devices that may communicate with each other wirelessly. As shown, a user 910 may interact with one or more devices via a unified control interface 920. Interface 920 can be some form of universal remote control and/or smartphone application, as examples. In this way, user 910 can communicate with the different devices via a single interface.

As shown in FIG. 9, the various devices include a unified smart home platform 930, which may be a given CPE, such as described herein, that enables interfacing with various devices of standardized protocols, as well as performing various edge microservices and further providing independent communications with both an operator and one or more third party providers. Also, understand that platform 930 can be managed remotely via one or more operator servers, such as described herein.

Still referring to FIG. 9, platform 930 may communicate with devices such as IoT devices 940₁₋₃, each of which is shown to operate with a different standardized protocol, namely, a Matter device 940₁, a Zigbee device 940₂ and a thread device 940₃. Note that interactions between these devices may be intermediated, at least, in part via an interoperability manager 950. In an embodiment, interoperability manager 950 can be located within platform 930 and acts as a bridge to facilitate communication between devices that use different standardized protocols, such as Matter, Zigbee, and Thread. Its primary function is to ensure seamless interaction and data exchange between these devices by translating protocol-specific commands and messages into a unified format that all devices can understand. In this way, devices from different manufacturers (which may use different communication standards) work together within the same smart home ecosystem. The interoperability manager thus plays a crucial role in maintaining a cohesive and integrated smart home environment, enabling users to control and automate devices effortlessly despite protocol differences. Although shown at this high level in the embodiment of FIG. 9, many variations and alternatives are possible.

While the present disclosure has been described with respect to a limited number of implementations, those skilled in the art, having the benefit of this disclosure, will appreciate numerous modifications and variations therefrom. It is intended that the appended claims cover all such modifications and variations.

1. A gateway comprising:
a host main processing unit (MPU), the host MPU comprising at least one core and at least one first transceiver to communicate with one or more first wireless devices in a wireless local area network (WLAN) according to a Wi-Fi protocol;
an Internet of Things (IoT) device coupled to the host MPU, the IoT device comprising at least one second transceiver to communicate with each of one or more second wireless devices according to at least one standardized wireless protocol;
a first wireless driver to enable the communication with a first device of the one or more second wireless devices according to the at least one standardized wireless protocol comprising a Matter protocol; and
a second wireless driver to enable the communication with a second device of the one or more second wireless devices according to the at least one standardized wireless protocol comprising a Thread protocol.

2. The gateway of claim 1, wherein the host MPU is to execute a unified service platform agent to locally enforce unified security of communications between the gateway, the first device and the second device.

3. The gateway of claim 2, wherein the unified service platform agent is to initiate an authentication with a cloud server of an Internet service provider, and to request an authorization token, the authorization token to enable the gateway to directly securely communicate with a third party application provider.

4. The gateway of claim 1, wherein the host MPU comprises at least one edge node to perform edge processing within the gateway and communicate with at least one cloud server of an Internet service provider, the at least one cloud server comprising an edge microservice orchestrator.

5. The gateway of claim 4, wherein the host MPU is to execute an edge microservices manager to manage the at least one edge node and communicate with the edge microservice orchestrator.

6. The gateway of claim 1, wherein the host MPU comprises at least one artificial intelligence (AI) circuit to locally execute AI operations on the gateway.

7. The gateway of claim 1, wherein the gateway further comprises a middleware agent comprising:
a plurality of wireless protocol agents comprising:
a first wireless protocol agent to perform protocol operations for the Matter protocol and interface with the first wireless driver; and
a second wireless protocol agent to perform protocol operations for the Thread protocol and interface with the second wireless driver;
at least one first application programming interface (API) to provide an interface between a unified service platform agent and the plurality of wireless protocol agents; and
at least one second API to provide an interface between the first wireless protocol agent and the first wireless driver and between the second wireless protocol agent and the second wireless driver.

8. The gateway of claim 7, wherein the at least one first API is to communicate according to a first standardized device data model and the at least one second API is to communicate according to a standardized kernel interface.

9. The gateway of claim 7, wherein the middleware agent is to enable the first device to communicate with the second device, wherein the first device is to communicate with the gateway via the Matter protocol and the second device is to communicate with the gateway via the Thread protocol.

10. A method comprising:
performing, via a cloud controller of at least one cloud server of an operator of an Internet service provider, a first authentication with a customer premises equipment (CPE) located at a user location remote from the at least one cloud server;
after the first authentication, performing a second authentication with a third party application provider;
receiving a request from the CPE for direct secure communication between the CPE and the third party application provider; and
in response to the request, providing an authentication token to the CPE to enable the CPE to directly securely communicate with the third party application provider using the authentication token and without involvement of the cloud controller.

11. The method of claim 10, further comprising sending, from the cloud controller to the third party application provider, the authentication token to enable the third party application provider to securely communicate with the CPE.

12. The method of claim 10, further comprising provisioning the CPE for the user location, the CPE comprising a plurality of wireless protocol stacks to enable the CPE to communicate within one or more mesh networks of the user location according to a plurality of standardized wireless protocols.

13. The method of claim 10, further comprising:
receiving a synchronization message from the CPE, the synchronization message based on local artificial intelligence processing in the CPE; and
synchronizing with at least one cloud service in the at least one cloud server based at least in part on the synchronization message.

14. The method of claim 10, further comprising sending, from the cloud controller, an update for a first wireless protocol stack of the CPE via a unified service platform agent of the CPE to cause the first wireless protocol stack to be updated without user involvement.

15. The method of claim 10, further comprising:
initiating, via the cloud controller, a security check of the CPE; and
based at least in part on the security check, performing an update of the CPE via the cloud controller without involvement of a user of the CPE.

16. A computer-readable medium comprising instructions that when executed by at least one processor of a customer premises equipment (CPE) cause the CPE to perform a method comprising:
performing a first authentication with a cloud controller of at least one cloud server of an operator of an Internet service provider, the CPE located at a user location remote from the at least one cloud server;
sending a request to the cloud controller to seek authorization to securely directly communicate with a third party application provider;
in response to the request, receiving an authentication token; and
using the authentication token, directly securely communicating with the third party application provider.

17. The computer readable medium of claim 16, wherein the method further comprises:
communicating with a first wireless device in a network at the user location via a first wireless driver of the CPE according to a Matter protocol; and
communicating with a second wireless device in the network at the user location via a second wireless driver of the CPE according to a Thread protocol.

18. The computer readable medium of claim 16, wherein the method further comprises:
performing, within an edge node of the CPE, edge processing of sensor information received from a first wireless device in a network at the user location; and
after performing the edge processing, communicating with an edge microservice orchestrator of the at least one cloud server.

19. The computer readable medium of claim 18, wherein the method further comprises:
analyzing, via an artificial intelligence (AI) engine of the CPE, a result of the edge processing; and
based on the analyzing, performing one or more operations in the CPE.

20. The computer readable medium of claim 16, wherein the method further comprises:
receiving, in the CPE, sensor information from a first wireless device in a network at the user location;
providing at least a portion of the sensor information to an edge node for edge processing to obtain edge processing result information;
performing, in the CPE, real-time analysis of the edge processing result information; and
based at least in part on the real-time analysis, performing, via an artificial intelligence agent of the CPE, one or more local actions within the CPE.
